(19) United States
(12) Patent Application Publication
(10) Pub. No.: US 2014/0173976 A1
(43) Pub. Date: Jun. 26, 2014

(54) PELLETS AND BRIQUETS FROM COMPACTED BIOMASS

(71) Applicant: AMERICAN PELLET SUPPLY LLC, Carlisle, IN (US)

(72) Inventors: Michael B. Myers, Shelburn, IN (US); Jay J. Hood, Commerce, OK (US)

(73) Assignee: AMERICAN PELLET SUPPLY LLC, Carlisle, IN (US)

(21) Appl. No.: 14/056,764

(22) Filed: Oct. 17, 2013

Related U.S. Application Data
(63) Continuation of application No. 12/786,774, filed on May 25, 2010, now abandoned.
(60) Provisional application No. 61/181,101, filed on May 26, 2009.
(60) Provisional application No. 61/245,506, filed on Sep. 24, 2009.

(51) Int. Cl. B01J 20/30; C10L 5/44

(52) U.S. Cl. CPC B01J 20/3035; C10L 5/44; B01J 20/3042
USPC 44/576; 44/589; 502/401; 502/404

(57) ABSTRACT

Certain disclosed pellets, briquettes, and other compacted products contain multiple components and have a composition tailored to meet specific requirements for a given application. Frequently, at least one of the components is a biomass component. The compacted biomass products can be used in various applications including power generation, animal bedding, and waste absorbent. One particular embodiment involves using compacted body or mass as a fuel supplement or fuel replacement for coal or other fossil fuel(s) in co-firing power plants. Other specific applications include bedding for various animals including fowl, horses, and rabbits. Another application comprises pelletized absorbents such as cat litter for absorbing liquid and/or solid waste products.

### CROSS REFERENCE TO RELATED APPLICATIONS

This application is a continuation of U.S. patent application Ser. No. 12/786,774, by Myers et al., entitled PELLETS AND BRIQUETS FROM COMPACTED BIOMASS and filed May 25, 2010, which application claims benefit of U.S. Provisional Patent Application No. 61/181,101, filed May 26, 2009, and also claims benefit of U.S. Provisional Patent Application No. 61/245,506, filed Sep. 24, 2009, all of which patent applications are incorporated herein by reference in their entireties and for all purposes.

### BACKGROUND

As the human population grows ever larger and imposes more demands on limited available resources, the need for greater use of waste products, particularly those from renewable sources such as crops and other plant or animal matter, has become compelling. While recycling programs and movements to use products from renewable sources have gained traction, many challenges remain. These challenges are particularly acute in the energy sector of the world's economies. They include finding compositions that are inexpensive to manufacture, easy to transport, easy to store, and of course environmentally benign.

### SUMMARY

The present invention provides compacted products, typically in the form of briquettes and/or pellets that include substantial amounts of biomass feed stocks. These products, whose compositions and manufacturing are described in detail herein, find many applications, principally in co-firing power plants, animal bedding, absorbent products, landscaping, and home heating.

Certain aspects of the invention pertain to a compacted body characterized by the following features: (a) first particles containing a biomass material, and (b) second particles containing a different material (which may optionally be biomass). The compacted body containing the first particles and the second particles resists fragmentation. It often includes a material acting as a binder. In various embodiments, the compacted body is combustible. Nevertheless, the second particles need not be combustible. Of course, the compacted body may include additional components such as third particles having a composition different from that of the first particles and the second particles.

The compacted body may have properties tailored for particular applications such as combustion, absorption, appealing appearance, etc. In some cases, the compacted body has a total moisture content of about 9% by weight or less. For combustion applications, the compacted body may have an energy density of at least about 7000 BTU per pound when combusted. Further, the compacted body may be composed to produce ash at a level of about 4% or less during combustion. In some embodiments, the second particles are coal particles.

It may be desirable to have compacted products that consistently maintain certain properties (e.g., particular levels of energy content, cost, absorbency) regardless whether certain feedstocks remain available. To this end, many different types of feedstocks are usable to produce the compacted products described herein. Numerous suitable biomass component are disclosed herein, among which are soybean stocks, sage, wood products, corn stocks, and sunflower stocks. Additionally, various paper and cardboard products, including waxed cardboard, may be used. Other materials that may be used with the first and second components of the compacted body include starch, plastic, fish oil, soda, lime, paraffin, vegetable oil, coffee grounds and animal fat. In a specific embodiment, the compacted body contains essentially only cardboard, an agricultural stock and a deodorizing component.

The compacted product may take on many different forms as appropriate for particular applications. In many cases, the product is a pellet or briquette. Of course, the size and shape may vary as appropriate for the end use. In some cases, the compacted body has an average dimension of about 0.25 to 4 inches.

Often the compacted body is provided together with numerous other similar compacted bodies (e.g., pellets or briquettes of similar compositions and/or properties) in a container appropriate for a particular application. For example, the body may be provided in a collection of compacted bodies present in a container at a coal fired plant.

Another aspect of the invention pertains to methods of preparing a compacted body as described above (e.g., a compacted product including first particles containing biomass and second particles of a different material). The method may be characterized by the following operations: (a) processing a biomass feedstock to convert raw feedstock to a form comprising said first particles; and (b) concurrently compacting the first particles and the second particles to produce the compacted body. In some cases, the compacting takes place in a briquette press, in which case the compacted body is a briquette. In some other cases, the compacting takes place in a pellet mill, in which case the compacted body is a pellet. Frequently, the compacting is performed with a binder, which may help preserve the life of the equipment employed to manufacture compacted products. In certain embodiments, the binder is algae or wax.

These and other features and advantages of the invention will be described in detail below with reference to the associated drawing.

### BRIEF DESCRIPTION OF THE DRAWING

FIG. 1 is a schematic diagram depicting an example a fabrication process for preparing compacted biomass products in accordance with certain embodiments of the invention.

### DESCRIPTION OF A PREFERRED EMBODIMENT

### Introduction

This invention pertains to pellets, briquettes, and other compacted products containing multiple components and having a composition tailored to meet specific requirements for a given application. Frequently, at least one of the components is a biomass component. The compacted compositions of this invention can be used in various applications depending upon their composition and cost. The following discussion will focus on power generation applications. One particular embodiment involves using compacted body or mass as a fuel supplement or fuel replacement for coal or other fossil fuel(s) in co-firing power plants. Other applications of specific interest include landscaping pellets and bedding for various animals including fowl, horses, and rabbits. Another application comprises pelletized absorbent such as cat litter for absorbing liquid and/or solid waste products.

The following non-limiting definitions are provided as an aid to understanding the invention described herein.

Compacted Mass or Body—a mechanically stable combination of particles not easily separated during processing in an intended application. In other words, the compacted body resists fragmentation or spalling when handled by conventional feeding, transporting, and conveying apparatus. A compacted body is typically formed under pressure (e.g., compression or compaction) by for example a pellet mill or a briquette machine. In some embodiments, the compacted mass or body will be a heterogeneous composition (e.g., it will contain particles of different components).

Feedstock—The raw material used in making the compacted mass or body. A feedstock will typically be a particulate or powdered material, although it may also be, e.g., a gum, syrup, or liquid.

Particle—A small discrete mass used to form a compacted body. A particle is typically, though not necessary, of homogeneous origin. Collectively, the particles may be a powder or granular product. Individual particles may have many different shapes and may be, e.g., fibers.

Biomass—Material derived directly from living matter, often plant materials or animal waste. Frequently, biomass is used as one or more components of a compacted mass or body described herein.

### Compacted Body Composition

For power plant co-firing applications, compacted products should, in certain embodiments, meet at least three criteria. These include (1) high energy content per volume or mass (sometimes referred to as BTU value), (2) low ash production, and (3) low sulfur content. Additionally, the products may need to meet a fourth criterion: (4) low net carbon generation. Low carbon, low ash, and low sulfur can all be considered in comparison to coal or other displaced power plant fossil fuel. Most of the biomass feedstocks employed in this invention will automatically meet the fourth criteria. In most cases, they will also meet the second and third criteria, although different component materials may produce different levels of ash and sulfur oxides. Ash is non-combustible solid component of fuel. It should also be noted that the cost of the raw material is an important consideration.

High BTU density feedstocks include combustible vegetation and waste (such as municipal solid waste) products. Examples of waste products include paper and cardboard waste (e.g., magazines), as well as plastic wastes and food wastes (e.g., coffee grounds). Vegetation feedstocks include both crops intentionally grown to provide fuel and vegetation that would not otherwise be harvested (e.g., vegetation along roadside and prison grounds). Examples of vegetation feedstocks include switchgrass, Miscanthus, bean stumble, soy bean stocks (stalks and hulls), corns stocks and cobs, corn, sunflowers (including whole plants as well as portions including heads, stocks, and/or seeds), other plant seeds, hulls, and stalks, sage, wood (e.g., in the form of wood chips), tree waste (such as pine needles and pine tops), hay, straw (e.g., wheat straw and flax straw), sugar cane, sugar beets, sorghum, Sudan grass (including hybrids such as Sudan-sorghum hybrids), canary grass, cool season grasses, DDG (distillers dried grains, a byproduct of ethanol production), seaweed, algae, and coffee grounds. Other vegetation sources include warm season grasses, leaves, and forest waste. It is specifically contemplated that any one of the feedstocks identified herein may be used alone or in combination with any one or more other feedstocks identified herein. In a specific embodiment, the compacted bodies of this invention contain particles of a first biomass feedstock, which may be any of the feedstock materials listed herein, in combination with particles of a second biomass feedstock, which may be any of the other feedstock materials listed herein.

Miscanthus grass has a very high BTU content and can be grown sterile so that it does not produce seeds that could unintentionally propagate in other fields in the vicinity. The cost of planting Miscanthus grass is in the range of $1000 per acre. However, it need not to be replanted every year. It has a robust root system that will send up new grass every year. Miscanthus has been burned on a commercial scale in Denmark, using a 78-MW circulating fluidized bed combustor (50% co-firing with coal) and a 160-MW powdered fuel combustor (20% co-firing). See J. M. O. Scurlock, Miscanthus: A Review of the European Experience with a Novel Energy Crop, Environmental Sciences Division Publication No. 4845, ORNL/TM-13732, 1999. European growers have used a sterile hybrid of M. sinensis and M. sacchariflorus (Miscanthus Giganteus) as a fuel crop since the 1980s.

Soy bean stocks have particularly high energy density and are used in some important biomass fuels of this invention. Soy bean stocks are conventionally left in the field and have to chopped fine during the harvest to allow planting for the next season. A suitable rake can reclaim this material for use in the invention.

In certain embodiments, sage is employed as a feedstock. It has a very high energy density but precautions may be needed to prevent settling or separation of the sage oils which may separate and settle during shipment.

Wood, particularly in the form of wood chips, is another high BTU feedstock that can be used in certain embodiments of this invention. However, wood typically contains approximately 49% water when first harvested. To make a suitable feedstock for co-firing applications, some of this water should be removed. In some implementations, the water content of the wood feedstock is reduced to approximately 15% by weight or less, and in some embodiments about 12% by weight or less. Wood chips containing 49% moisture have only about 4,500 BTUs per pound, while dry wood chips have about 7,500 BTUs per pound. Various techniques known in the art may accomplish the needed reduction in water content.

However, the water content in wood is often represents a significant economic disadvantage. Thus, in certain embodiments, the compacted products have no wood content. Commonly, wood is employed in pellets for home heating applications. Aspects of the present invention employ pellets or other compacted products that have little or no wood, even when used for heating/combustion applications. Still other embodiments employ only a small amount of wood (e.g., 5% by weight or less or even about 1% by weight or less) to impart a pleasing odor to the product.

In some cases, non-combustible additives are included in the otherwise combustible composition. For example, non-combustible materials that are normally required in coal-fired plants may be included in the compacted bodies. Some of these additives help reduce emissions or waste in plants. One such example is lime, which may be used to control clinkers in coal-fired power plants. Other materials that control the combustion rate or other combustion characteristics of the biomass feedstock and/or coal may also be added. Examples include carbonate and bicarbonate salts (e.g., sodium bicarbonate or baking soda). Still other non-combustible materials serve to bind the components or particles of the compacted bodies. One example of such material is boron-oxygen containing materials such as borax.

In some embodiments, combustible fossil fuel components may be added to compacted bodies for power plant applications. Examples of such components include coal, coke, anthracite, lignite or charcoal and mixtures thereof. Coal fines are a particularly useful feedstock for blending with biomass feedstocks. Blending coal dust and biomass components allows one to provide power plants with a single pre-blended product rather than two separate feed streams. In a specific example, a compacted product comprises approximately 85% by weight coal dust and approximately 15% by weight biomass (e.g., dried wood, soybean stubble, and/or grasses).

In certain embodiments, other additives include materials that improve the mechanical or handling properties of the compacted products. An example of such material includes starch, which facilitates cohesive binding of the individual feedstock particles or granules to form the compacted products. Moisture in, e.g., the form of steam provided to the pellet mill (or other pellet fabrication apparatus) may also serve as a binder. Many biomass feedstocks contain lignin or related material that naturally serves as a binder when the biomass is treated thermally, as may be the case in a pellet mill or briquette press. Other examples of binding agents include borax, pitch, wax (including paraffin, bees wax, and/or carnauba), and algae.

A challenge faced in using biomass fuel supplements for power plants is in providing a sufficient quantity of the supplement to make a meaningful contribution to the reduction of fossil fuels. Seasonal and other fluctuations in available crop-based biomass products can result in temporary shortages of needed fuel to operate power plants. To this end, the inventors have recognized that it will be desirable to include non-crop based fuel components to certain compacted products for power plant applications.

Examples of non-crop based fuel supplements other than fossil fuels that impart one or more desirable properties to the pellets include syrup for making beverages such as Coca Cola®. When such syrups pass their useful shelf life, they must be disposed of, which can be expensive. Landfill is often the only option. Syrups such as coke syrup provide reasonable energy content and improve the binding of the compacted bodies. Other examples of waste products having similarly useful binding properties include starch, plastic, fish oil, soda, lime, paraffin, vegetable oil, coffee grounds and animal fat for improving energy content. Other than soda and lime, all of these materials have good energy content. Municipal waste may be a large source of biomass for the compacted products of this invention. Such waste may include high and/or low density polymers, paper, etc. As mentioned, paper products including cardboard may be employed in compacted products for co-firing applications. In various embodiments, treated forms of paper such as waxed paper or waxed cardboard are employed in the compacted products. In specific embodiments, waxed cardboard is present in an amount of about 1 to 10% by weight of a compacted product, which may be available for combustion applications, and other applications.

As indicated above, the compacted products disclosed herein may include one or more “binders” which serve to maintain (or facilitate maintenance of) the products in their compacted or densified form. In some cases, this means that such binder or binders will prevent (or help prevent) separation of the compacted body into smaller pieces or into its component particles. Some compacted bodies will resist such separation when faced with mechanical agitation or jostling, as is typically encountered during transportation (as by train, truck, airplane, etc.), processing or conveying preceding combustion, loading into storage facilities, etc. Some compacted bodies will resist such separation when exposed to outdoor environments, such encountered in open containers prior to combustion, which may include rain, winds, frozen precipitation, and extremes in temperature and humidity. In various implementations, binder is present in compacted bodies at a concentration of up to about 10% by weight, or up to about 5% by weight, or up to about 2% by weight. In a specific example, binder is present in the range of about 0.1 to 1% by weight.

In certain embodiments, binding is provided via moisture content provided before or during compaction in a press, mill, etc. Steam may be used as explained herein. For some applications, particularly co-firing or other combustion embodiments, the amount of moisture will be relatively small in order to not unduly compromise the energy content of the compacted product. In some such applications, the compacted body will contain not more than about 5% by weigh moisture as a binder, preferably not more than about 2% by weight.

In various embodiments, the binding is provided by a material of high energy density that is tacky or becomes tacky during formation of the compacted body. Note that the formation process often involves elevated temperature and/or pressure (elevated substantially beyond standard temperature and pressure (STP)). Under such conditions, some plant or other materials change chemical and/or physical form to become sticky or even viscoelastic and thereby bind together components of the compacted body. One specific example is wood which contains lignins, which become sufficiently tacky under the temperature and pressure of processing to serve as effective binders.

Algae and blue-green algae (collectively “algae” herein) is another biomass material that has been found to serve as an effective binder. Algae often contains a suitably high energy density and low sulfur content for combustion applications, and it is inexpensive, easy to harvest and rapidly process to a form having low water content, and resists absorption of water when present as a binder in compacted bodies of this invention. Examples of suitable algae for use herein include green algae, brown algae, and red algae, as well as blue-green algae (cyanobacteria). Various forms of bacteria such as purple and green sulfur bacteria may similarly be used. In accordance with certain embodiments, the algae is harvested from water-based growth medium (e.g., a greenhouse or outdoor body of water) and optionally transported for further processing as a slurry, a dried and/or pressed solid, or auger driven tacky material. It may be optionally filtered, pressed, centrifuged, air dried, etc. prior to combination with other components to form a compacted body of this invention. Such processing may remove water and/or change the properties of the algae to facilitate transportation, processing to compacted bodies, and/or improvement in binding properties. Harvesting may involve netting, stirring with a rod or other capture device, drying, etc.

The algae binder may be combined with the other components and processed to produce compacted products according to one or more of the various methods described elsewhere herein. In some embodiments, the algae used as a binder in the final product will contain some amount of moisture (e.g., up to about 10% by weight). Regardless of the moisture content in the algae, it may be present in the final compacted product in an amount of, e.g., about 0-10% by weight, or even higher in some embodiments due to its high energy density. In certain specific embodiments, the algae is present in concentration of about 0.1 to 2% by weight of the final product.

In some cases, algae or a related product is used as a coating on individual compacted bodies or as a coating or web over a pile or other collection of compacted bodies in order to preserve the structure of the bodies and thereby resist separation into smaller pieces or the constituent particles. Such cases should be distinguished from the situation where algae is intimately mixed with the other components of the compacted bodies as with conventional binders.

In many markets, the cost of the feedstocks used to prepare compacted products will fluctuate significantly. Therefore, the compositions of the product provided to power plants may be adjusted accordingly in order that the costs remain reasonably controlled regardless of feedstock cost variations. However, it will be desirable to maintain a consistently high BTU content and low ash generation, regardless of the compacted product's composition. Examples of suitable “guaranteed” criteria for co-firing applications will be set forth below.

It should be understood that required combinations of product properties will vary from application to application or customer to customer. Through the mixing of feedstocks and certain additives, one can provide custom biomass fuel products that maintain the quality standards required for various applications. Further, if one feedstock becomes unobtainable one can select one or more replacement feedstocks and process them into a comparable product that meets all of the requirements for the customer.

In some cases, the compacted product compositions of this invention contain up to and including 100% biomass. However, as indicated, more complex compositions are often employed. In certain embodiments, the compacted product composition may be generally characterized as follows: between about 5 and 100% by weight biomass, up to about 25% by weight of a non-combustible additive such as lime, and up to about 95% by weight of a fossil fuel such as coal fines. More typically, the compacted product will contain between about 15 and 100% by weight biomass, up to about 5% by weight of a non-combustible additive, and up to about 85% by weight of fossil fuel. In embodiments that do not employ a fossil fuel, the non-combustible component, if present, may be present in a level of about 5% by weight or less. Further, in embodiments without a fossil fuel component, the biomass portion may contain two more distinct types of biomass, sometimes chosen to provide a blended average value of energy density, ash content, and sulfur content to meet a public requirement (e.g., a government mandate) or a customer's criteria. Note that because paper products are derived from plant matter, they are deemed to be “biomass” as that term is used herein.

The following examples illustrate ranges of biomass components in compacted bodies having two or more components.

Waste paper (e.g., cardboard)—about 50-95% by weight, and in more specific embodiments about 60-85% by weight.

Lime—about 0.5 to 10% by weight and in more specific embodiments about 2 to 7% by weight.

Soybean waste—about 5 to 100% by weight and in more specific embodiments about 50 to 80% by weight.

Dried wood (approximately 15% by weight or less water)—about 5 to 100% by weight and in more specific embodiments about 25 to 75% by weight.

Switchgrass—about 5 to 100% by weight and in more specific embodiments about 50 to 90% by weight.

Miscanthus—about 5 to 100% by weight and in more specific embodiments about 40 to 90% by weight.

Corn—about 5 to 100% by weight and in more specific embodiments about 40 to 90% by weight.

DDG—about 5 to 100% by weight and in more specific embodiments about 20 to 80% by weight.

Municipal waste—about 5 to 100% by weight and in more specific embodiments about 30-90% by weight. This may include one or more of paper, cardboard, high density plastic, and low density plastic.

In some specific embodiments, the composition includes a combination of usable municipal waste, natural grasses, and stocks from agriculture, with optional and varying other products. Stocks from agriculture may include stalks, husks, hulls, and the like. In various embodiments, the composition includes about 30-90% municipal waste, about 40-90% grasses, and about 40-80% agricultural stocks, all percentages by weight. The municipal waste may include cardboard, particularly waxed cardboard.

Representative compacted product compositions follow: (1) soybean stocks about 25% cardboard about 75%, (2) corn stocks about 25% cardboard about 75%, (3) Miscanthus about 25% cardboard about 75%, (4) sunflower stocks about 25% cardboard about 75%, (5) whole sunflowers, stocks, heads and seeds about 20% cardboard about 80%, (6) a warm season grass about 25% cardboard about 75%, (7) straw about 20% cardboard about 75%, and (8) switch grass about 25% cardboard about 75%. Wood chips, pine needles, pine tree tops, sage and all grasses, alone or in combination can replace or supplement the cardboard. All percentages are provided on a per weight basis. In the above examples, and throughout this document, when cardboard or paper is mentioned, some fraction, or all, of the component may be waxed, which means that the component has some amount of wax (e.g., paraffin or bees wax) coated onto or impregnated into the paper or cardboard.

For co-firing applications, the compacted products of this invention may employ one or more of the following biomass components: sage, soybean stocks, corn stocks, sunflower stocks, seeds, and heads, dried wood, and grasses. For industrial scale co-firing applications such as power plant applications, these products will be provided in high volumes, often on the order of tons to several tons per day. It is believed that biomass can replace up to about 15% of the total energy input at coal-fired plants with only minor modifications.

In certain embodiments, such as some of those employed to for landfill restoration applications, the compacted products may include fertilizer and/or grass seed. Additionally, in some embodiments, the compacted structures (particularly pellets) are colored for landscaping and landfill reclamation applications. For example, natural black, green, and/or red pellets may be employed for landscaping applications. In certain specific embodiments, landscaping pellets may be employed for flowerbeds and trees.

### Compacted Body Form

As indicated, embodiments of this invention pertain to compacted products such as pellets or briquettes. Other forms of compacted body include logs and beads. One could provide fluffy feedstock to a power plant, but transporting such material has been found to present certain challenges. Particularly, the vibration experienced by the feedstock in a truck bed during transportation can compact the feedstock to such an extent that some of it becomes quite hard and very difficult to remove. Pelletized or briquetted biomass feedstock avoids this problem. Further, pelletized mixtures of combined feedstock materials (and possibly other materials in combination with such feedstocks) resist separation during transport.

Compacted bodies employed in this invention may have a wide range of sizes and shapes. In some embodiments, the bodies are pellets having substantially cylindrical or spherical shapes. They are generally no larger than about two inches in length or diameter, and typically no larger than about one inch. In a specific embodiment, the compacted bodies are pellets having a length of at most about 1.5 inches and a diameter of about 0.25 to about 0.313 inches as specified by the Pellet Fuels Institute to assure predictable fuel amount and prevent jamming.

Briquettes generally have a square or rectangular profile and may have curved or angular faces. In certain embodiments, they will generally dimensions of about 1 to 4 inches along the rectangular sides and dimensions of about 0.5 to 3 inches in the third dimension.

Regardless of the final form (size and shape) of the compressed bodies, they should resist breakage or crumbling during handling in accordance with their intended applications. They should produce only a limited amount of dust from breakdown to avoid dust while loading and operation. In a specific embodiment, the compressed bodies produce fines passing through ⅛ inch screen at a level of no more than about 0.5 percent by weight of compressed bodies. Typically, though not necessarily, the compacted bodies in a collection of such bodies have a relatively uniform size and shape. In some cases, the standard deviation in size of compacted pellets in a collection is about 0.3 inches or less.

The compacted bodies of this invention will generally be composed of relatively small particles having dimensions on the order of about 0.1 inches or less. Often the particles have an average size of between about 0.1 and 5 millimeters.

### Compacted Body Properties

The compacted products disclosed herein may be defined, at least in part, based on their properties. Often those properties will be pertinent to a particular application. Further, the properties may be invariant regardless of the constituent materials employed to make the products. This will frequently be necessary because the properties of biomass feedstocks can vary widely and because some feedstocks may become unavailable or prohibitively expensive. As indicated, the compositions of the compacted products may be adjusted to accommodate changing needs and availability. Often two or more biomass feedstock materials are employed in a given compacted product.

In the case of a product for co-firing applications, the following properties may define a compacted body provided in accordance with certain embodiments:

BTU density—At least about 7000 BTU/pound, and in some cases at least about 8500 BTU/pound, and in further embodiments, at least about 9500 BTU/pound.

Sulfur Content—Less than about 1% by weight, and some cases less than about 0.5% by weight.

Ash Production—Less than about 10%, and in some cases less than about 7.5%, and in specific embodiments less than about 5% by weight. In some cases, the ash content is about 4% by weight or less. Of course, higher ash contents may be encountered with compositions such as those employing coal fines. Ash content may be expressed as the percentage of residue remaining after dry oxidation (e.g., oxidation at 550 to 600° C. in oxygen). In some cases, the ash content is determined with respect to the solids content of the combustable material prior to firing.

Examples of typical values of these parameters for various feedstocks are presented in the following table (which contains data adapted from publically available sources).

| Product | BTU/LB | Sulfer % | Ash % | Moisture % |
|---|---|---|---|---|
| Alfalfa | 6934 | | 7.94% | 12.25% |
| Alfalfa | 7729 | | 9.06% | 0% |
| Aspen | 7786 | 0.02% | 2.48% | 6.02% |
| Aspen | 8501 | 0.02% | 2.67% | 0% |
| Corn Gluten Feed | 7199 | 0.33% | 3.78% | 12.06% |
| Corn Gluten Feed | 8097 | 0.38% | 4.30% | 0% |
| Shelled Corn | 6924 | 0.11% | 1.13% | 13.43% |
| Shelled Corn | 8100 | 0.11% | 1.23% | 0% |
| Corn Cob | 7369 | 0.04% | 2.16% | 7.12% |
| Corn Cob | 7911 | 0.04% | 2.32% | 0% |
| Corn Stocks | 7057 | 0.04% | 6.81% | 9.14% |
| Corn Stalks | 7768 | 0.04% | 7.64% | 0% |
| Dried Distillers Grain | 8459 | 0.40% | 4.16% | 9.27% |
| W/solubles | | | | |
| Dried Distillers Grain | 9422 | 0.45% | 4.13% | 0% |
| W/solubles | | | | |
| Dried Distillers Grain | 8473 | 0.34% | 1.96% | 13.25% |
| W/O Solubles | | | | |
| Dried Distillers Grain | 9848 | 0.36% | 2.24% | 0% |
| W/O Solubles | | | | |
| Oats | 7143 | 0.14% | 3.17% | 12.49% |
| Oats | 8242 | 0.16% | 3.58% | 0% |
| Soybeans | 8783 | 0.29% | 5.19% | 10.25% |
| Soybeans | 10230 | 0.33% | 6.22% | 0% |
| Soybean Hulls | 6660 | 0.07% | 4.17% | 11.38% |
| Soybean Hulls | 7570 | 0.08% | 4.22% | 0% |
| Soybean Stalks | 9042 | | 3% | 15% |
| Wheat straw | 6839% | 0.07% | 10.40% | 8.26% |
| Wheat straw | 7375 | 0.08% | 11.33% | 0% |
| Oat straw | 7153 | 0.05% | 7.90% | 6.91% |
| Oat straw | 7626 | 0.06% | 8.49% | 0% |
| Sugar Beat Pulp | 6597% | 0.14% | 3.80% | 9.70% |
| Sugar Beat Pulp | 7345 | 0.16% | 4.31% | 0% |
| Sunflower Hulls | 8474 | 0.14% | 2.86% | 8.56% |
| Sunflower Hulls | 9654 | 0.16% | 3.13% | 0% |
| Sunflower Seeds | 12,000 | | | 8% |
| Wheat Middlings | 7228 | 0.15% | 5.18% | 12.58% |
| Wheat Middlings | 8415 | 0.17% | 6% | 0% |
| Newspaper | 7975 | | 1.50% | 6% |
| Brown Paper | 7250 | | 1% | 6% |
| Corrugated Paper | 7040 | | 5% | 5% |
| Plastic Coated Paper | 7340 | | 2.60% | 5% |
| Coated Milk Cartons | 11,330 | | 1% | 3.50% |
| Citrus Rinds | 1,700 | | 0.75% | 75% |
| Shoe Leather | 7,240 | | 21% | 7.50% |
| Buty Sole Composi- | 10,900 | | 30% | 1% |
| tion | | | | |
| Polyethylene | 20,000 | | 0% | 0% |
| Polyurethane | 13,000 | | 0% | 0% |
| Latex | 10,000 | | 0% | 0% |
| Rubber Waste | 10,000 | | 20% | 0% |
| Carbon | 14,093 | | 0% | 0% |
| Paraffin Wax | 18,621 | | 0% | 0% |
| Wax Paper | 11,500 | | 3% | 1% |
| Tar and asphalt | 17,000 | | 1% | 0% |
| Wood Sawdust | 8,000 | | 3% | 10% |
| Rags | 7,200 | | 2% | 5% |
| Animal Fats | 17,000 | | 0% | 0% |
| Cotton seeds | 8,000 | | 2% | 10% |
| Coffee Grounds | 10,000 | | 2% | 20% |

Other pertinent properties of the compacted products may include density, maximum concentration of certain elements, total liquid content. In various embodiments, compacted bodies are bodies that are significantly denser than their uncompacted components (the feedstock). As an example, a compacted body may be reduced in volume by at least about 5 times compared to the corresponding volume of the uncompacted feedstock. Typically, but depending in part on moisture content and particle size, compaction results in a volume reduction of between about 10 and 15 times. As explained above, a binder may facilitate this level of densification. In typical embodiments, the compacted product will have a density of between about 20 and 40 pounds/cubic foot. In some cases, the density is even greater, e.g., at least about 40 pounds/cubic foot.

In another specific embodiment, chlorides are present at a level of no more than about 300 parts per million to, e.g., avoid combustion chamber and vent rusting or other form of corrosion. In certain embodiments, the moisture content of the compacted products is about 15% or less; in some cases less than about 10% or less, and in a specific embodiment about 9% or less—all by weight.

Additionally, various compositions have energy contents (e.g., mass-based energy densities) that are about 15 to 30% higher than the energy densities of comparable wood pellets. Examples product compositions having such high energy densities are those employing a combination of municipal waste, natural grasses, and stocks from agriculture. In a specific example, the product composition includes about 30-90% cardboard, about 5-40% natural grasses, and about 5-60% agriculture stocks.

Among the various advantages of compaction are the following: sterilization of the product from heat produced in the process, improved storability, relatively constant size of product, elimination of settling of materials that make up the product, dust reduction, improved shelf life, ease of handling and transport.

### Methods of Producing Compacted Bodies

Various techniques may be employed to produce compacted biomass products in accordance with this invention. Typically, one or more feedstocks are provided to a compacting apparatus. Some pre-compacting operations may be performed. Additionally or alternatively, some post-compacting operations may be performed. All compositions and properties of all compacted bodies described elsewhere herein may be produced in accordance with the methods of this section.

Depending on the feedstock condition, it may be necessary to perform one or more separation or other procedures prior to compacting. For example, a mix wagon, which is a wagon conventionally used in farms for the purpose of breaking bales of hay or other vegetable matter into straw, etc., may be used to put baled feedstocks in a condition suitable for further processing. Thus, in some cases, bales of grass and/or other raw feedstocks are initially fed into a mix wagon, where the bales are broken and the resulting material is mixed and delivered to one or more grinding stages. A conveyor may be employed to move the material from the broken bales to these stages.

In some cases, the feedstock is a component of municipal waste obtained by sorting components of that waste. In one example, recycling waste containing high energy density plastics and/or paper in addition to glass, metal, and/or low density plastic is sorted to extract the high density plastics and/or paper. Various tools are available to facilitate such sorting. One such product is vended by Komar Industries of Groveport, Ohio. The vast amounts of biomass required for some power plants to replace or supplement coal can be provided in part using municipal waste. Further, use of such waste for fuel or other combustion applications eliminates the cost and environmental degradation of landfilling the waste.

It may be desirable to employ specialized conveyors to handle the various different feedstocks employed in the process. So regardless of whether the process requires paper, cardboard, municipal waste, agricultural products (such as bales of grasses or farm crop waste), or other feedstock, the conveyance mechanisms will appropriately handle the particular feedstock based on its particular characteristics (size, density, shape, fragility, etc.).

In some cases, the raw feedstocks will be provided with a particle size and density that allows them to be fed directly to the compacting apparatus. In other cases, however, the feedstocks are provided in a form requiring some pre-processing to achieve a desired particle size and overall density. That is, the feedstock must be converted to a condition that is suitable for feeding to a pellet mill, briquette press, or other compacting apparatus. For many applications, it is desirable that the feedstock supplied to the compacting apparatus have a low density, and even sometimes a fluffy constitution. Thus, in some embodiments, the processing apparatus includes one or more feedstock reduction stages upstream from a compacting stage. Such apparatus may include hammer mills and similar tools.

Some feedstocks such as damp agricultural feedstocks, may require partial drying to attain a moisture level suitable for the process. Drying may be accomplished by various techniques known in the art. In one example waste energy from other aspects of the process are employed to dry the feedstock. For example, some processing apparatus employ a cyclone to remove dust at various stages of the process. The air from the cyclone exhaust may be employed to dry damp feedstocks.

In some cases, separation and/or pulverization is performed separately on each single type of feedstock, such that all feedstocks are separately treated. Remember that multiple different feedstocks may be combined to form pellets of predefined composition. In other cases, two or more feedstocks are treated together in a single processing tool (e.g., a hammer mill). Note that in embodiments employing multiple feedstocks, the individual feedstocks are generally mixed upstream from the compacting apparatus. The mixing of feedstocks may be performed continuously or in batches. In the case of batches, an operator may shovel or otherwise deliver the individual feedstocks to a mixer. Various mixers are suitable for use with this invention. Examples, include cattle feed mixers and the like. In a specific embodiment, the apparatus can blend up to four different feedstocks and adjust the feed rates of one or more of these to compensate for different densities of the raw materials.

In a specific embodiment, two separate hammer mills are employed to completely convert grass, cardboard, or other feedstock into a pulverized condition suitable for pelleting. The first hammer mill partially converts the raw feedstock to the appropriate condition for pelleting, while the second, downstream, hammer mill completes the conversion to a fully pulverized state. In some cases, three or more separate hammer mills or other pulverizing stations are employed to conduct the pulverizing or grinding. This approach has been found to work particularly well in the case of paper or cardboard feedstocks. It has also been found that hammer mills outfitted with knives are particularly useful reduce certain feedstocks.

As mentioned, the pulverized feedstock preferably has characteristics appropriate for use in a pellet mill or other compacting apparatus. Such characteristics may be dryness (e.g., about 8-14% moisture by weight), granule dimensions (e.g., about 0.1 to 5 millimeters), density, etc. For composite pellets comprised of multiple different feedstocks, there may be multiple separate inlet lines into the pellet mill, one for each of the various components. In certain embodiments, the pellet making apparatus will include a mixing chamber located upstream from the pellet mill. The various components of feedstocks used to form the composite pellets are fed to the mixing chamber through separate inlet lines. The mixing chamber combines these various feedstocks into a well mixed, typically evenly distributed, mixture that is then fed into the pellet mill. In other embodiments, the multiple feedstocks are mixed upstream of the compacting apparatus (e.g., in a mix wagon) by a batch or continuous process.

Various techniques may be employed to refine and transport the raw feedstock or pulverized feedstock from, e.g., a hammer mill or other pulverizing apparatus to the compacting apparatus. In one embodiment, a blower drives the pulverized material into a line or other conduit (e.g., an 8 inch line). In one embodiment, the processed feedstock is temporarily stored in a holding tank or other vessel until it is needed for conversion into pellets. In a specific embodiment, an auger driven feedline is provided at the bottom of a holding tank or elsewhere to convey the feedstock(s) through the processing system. In a specific embodiment, the auger feedline moves the processed material to a conveyor inside a pellet plant. Specifically, the conveyor may feed material into the top of the pellet mill. In the some embodiments, a material catch box is located at the top of the pellet mill.

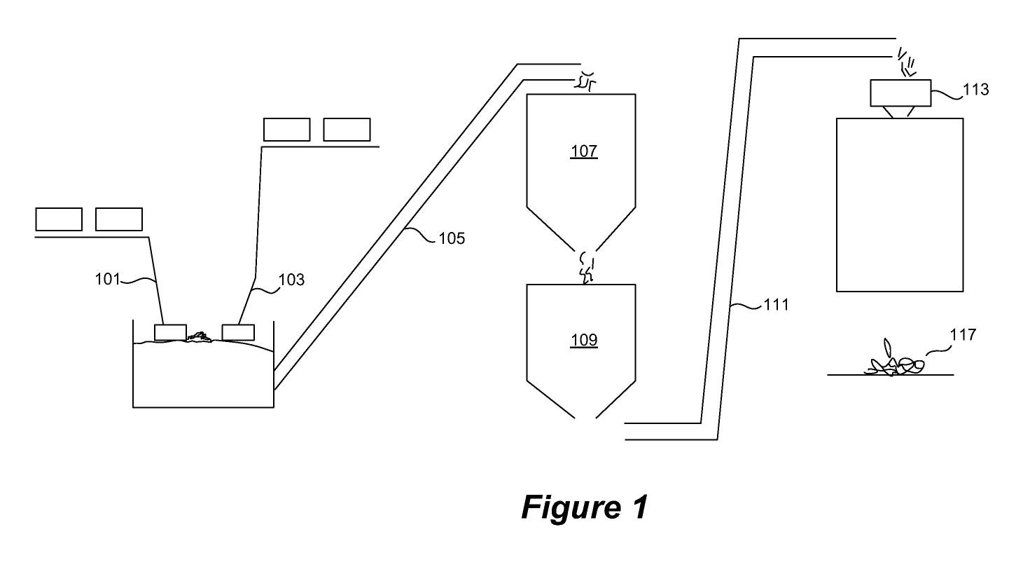

FIG. 1 depicts a specific embodiment in which harvested grass or other feedstock 101 and 103 is fed via a conveyor 105 upward to a top hammer mill 107. Gravity pulls the material processed in the top hammer mill 107 to an outlet located at the bottom of that hammer mill. From there, the partially converted feedstock material falls to a bottom hammer mill 109, where the conversion is completed as mentioned above. Optionally, the processed feedstock may be stored in a storage tank (not shown). In the depicted embodiment, an auger or pressurized air supply drives transport of the pulverized feedstock through a feedline 111 to a catch box 113, where it then passes into a pellet mill 115. The resulting pellets 117 are cooled, optionally packaged, and made available for the intended application (e.g., combustion).

Many types of pellet mills are suitable for producing pellets in accordance with the present invention. In various examples, the pellet mill includes a steam injector to facilitate binding of the raw material into pellets. One vendor of suitable pellet mills is California Pellet Mills (CPM) of Waterloo Iowa. When pellets are extruded and compressed in dies, much of the residual moisture introduced by the steam processing is removed. As mentioned, some pellets produced in accordance with the invention will have a designed size and shape. Dies used with the pellet mill are designed to produce pellets of the desired size and shape. In specific examples, ring or flat dies are used.

Pellets freshly produced by pellet mill are typically very hot, sometimes in a range of 140 to 200° F. Therefore, the pellets should be cooled before further processing or transport. In certain embodiments, the pellet producing apparatus employs a pellet cooler, which cools the pellets to a suitable temperature (e.g., about 60 to 120° F.). Subsequently, the cooled pellets may be introduced to a vibrating screen for screening out fines. The fines may be recycled for another pass through the pellet mill.

Various stages in the process may produce dust or other debris that could interfere with operations. In one embodiment, the layout of the process equipment on the floor provides conveyors of certain feedstock at positions where bales of agricultural products can filter out the dust or other debris. By capturing the dust from the process in the bales of agricultural feedstocks, some waste is returned to the process. In one example the process equipment includes a vacuum system (e.g., a cyclone fan) to move the dust or other debris from particular locations on the floor (e.g., below conveyors and/or pellet mills) toward feedstock bales which act as filters.

Often the compacted products should have relatively low moisture. This is the case, for example, when using the products for co-firing applications, where the presence of moisture reduces the BTU density. In certain embodiments, the compacted product forming process employs little or no drying. This goal may be realized by employing feedstocks that are already substantially dry; examples include materials that dry naturally on the land, under the sun. In contrast, compacted wood products are made from wood chips, which typically have a moisture content on the order of about 50% by weight and may need to be dried prior to forming pellets. Some feedstocks employed in the present invention have moisture levels at about 20% by weight or lower, or even about 15% by weight or lower (or about 10% by weight or lower). As described below, some compacting tools may themselves facilitate removal of moisture from a feedstock such as wood. Also as mentioned elsewhere, certain embodiments of the invention employ pellets having no wood content. Other embodiments employ only a small amount of wood (e.g., about 5% by weight or less or even about 1% by weight or less) to impart a pleasing odor to the product.

In one embodiment, wood products or other relatively high water content product is processed in a briquette press to remove the excess water. Wood chips or other wood product may be processed alone or in combination with other components (biomass or fossil fuel) to produce a resulting product with significantly reduced water content. For example, if wood chips contain approximately 49% water (by weight) prior to processing, compacting in a briquette press may reduce the water content to approximately 10-20% by weight.

A briquette press provides an energy efficient technique for removing water content from wood chips and other high moisture content feedstocks. In certain embodiments, a briquette press contains two opposing rollers with dies or indentations arranged about the perimeters of the rollers. The indentations are the size of the briquettes to be produced. The rollers may be driven by large motors, e.g., two 200 hp hydraulic motors. The raw material is fed from a hopper located above the press. The material falls in between the rollers and is compressed into briquettes by the rolling/compressing action of the rollers.

As mentioned, briquettes generally have a blockish profile and generally dimensions of about 1 to 4 inches along the sides. This side and shape renders them appropriate for direct feeding into coal fired plants. No further processing is necessary; the biomass briquettes can be mixed directly with the coal as it is fed to the power plant or combustion chamber. A briquette press may operate on the site of a power plant and produce briquettes for direct use, without the need to transport the final product.

Briquette presses come in various sizes. In some embodiments, suitable for use in producing briquettes for co-firing applications, a press is chosen that can produce at least about 50 tons/hour of briquettes. In some cases, the press can produce about 150 tons/hour of briquette.

In certain embodiments, fossil fuel and biomass components are combined to form a compacted product of this invention. One example of such product includes biomass together with coal fines or coal particles. The product may be, for example, a pellet or a briquette. In some cases, the biomass and coal components are mixed separately (in a separate mixer), and then put on conveyer where they are transported up to a hopper, which may sit on top of a briquette press. The briquette press then produces briquettes from coal and biomass as composite fuel products. In certain embodiments, a binder such as expired coke syrup or plastic may be added to the briquette press (along with the coal and biomass) to produce ensure a stable product.

The relative amounts of fossil fuel and biomass components in compacted products may mirror the relative amounts required for the intended combustion application such as co-firing in a power plant. In a typical co-firing application, about 5 to 20% by volume (e.g., about 15% by volume) of the fuel provided for combustion to a power plant is compacted biomass material with the remainder being coal or other fossil fuel. The total daily quantity of fuel to a typical power plant may be several tons, even hundreds of tons. In certain embodiments, a production method as described herein is used to produce about 10-15 tons of compacted fuel supplement per worker shift. In a typical example, a power plant may require about one million tons per year of combustible product, at least some which comprises compacted biomass materials of the type disclosed herein.

### Waste Absorbent and Bedding Applications

In many cases, biomass containing pelletized material can serve as cat litter or other similarly useful absorbent products. The components of such products may impart one of more of the following properties: low cost, odor reduction, odor masking, color, and of course absorbency. Examples of suitable low-cost absorbent materials include paper, including cardboard, and various agricultural stocks or other plant waste products such as hulls, husks, stalks, and pulp. Specific examples include soybean products (stalks and pods), corn products (husks, stalks, and cobs), and sunflower products (stalks). Paper based absorbent products employ at least about 40% paper and/or cardboard, either or both of which may be waxed.

Frequently, the absorbent compacted bodies include substantially no clay or similar conventional material used cat litter. In some embodiments, the absorbent material may include another absorbent material such as a super absorbent polymer (SAP). SAPS are widely used in diapers and similar products. They are often acrylate based polymers, but increasingly are derived from renewable plant-based resources.

Various deodorizing components such as cyclodextrin, corn starch, bicarbonates and/or lime may be present in small or even trace amounts (e.g., less than about 2% by weight or even less than about 1% by weight). When cyclodextrin or similar product is employed, it may be present at a level of about 0.05 to 0.1 weight percent. Certain odor masking component such as coffee grounds may also be present in small amounts (e.g., less than about 5% by weight). Other additives that may be provided in cat litter products include a small or even trace amount of soap and/or vegetable oil, typically less than about 0.1% by weight (e.g., about 0.01 to about 0.02% by weight).

Typically, the absorbent material contains at least about 50% by weigh biomass products. In various embodiments, the absorbent material includes between about 5 and 50% by weight of crop waste and between about 30 and 95% by weight of paper waste such as cardboard, together with a small amount of odor removing or masking material. In more specific embodiments, the material includes between about 10 and 30% by weight of crop waste and between about 65 and 90% by weight paper waste. In one specific embodiment, the absorbent composition containing pellets of about 80% by weigh cardboard (or cellulosic paper material more generally), about 20% by weight soybean, corn, and/or sunflower waste, and a small amount of odor absorbing material (e.g., cyclodextrin, corn starch, lime, or baking soda). Another specific composition has between about 50 and 90% by weight paper product, about 10 to 40% by weight corn product, and a deodorizing component as above.

In some cases, the litter or other absorbent material is composed of a heterogeneous mixture (mixed sizes) of particles and mixed cellulose fibers with similar densities. In certain examples, the density of the final product is between about 0.4 to 0.8 grams/cm³, or more specifically about 0.5 to 0.7 grams/cm³ (30 to 42 pounds per cubic foot). The average size of the litter pellets may be about ⅛ to ¼ inches in diameter (e.g., about 3/16 inches) and from about ¼ to 1½ inches in length. The pellets are typically extruded through a die and most of them break off so the end of the pellet can be concave, flat, or rounded. Typically, a given batch has a range of lengths.

The absorbent materials described here may be produced via a pelletizing process such as those described above. Typically, the process employs relatively small amounts of moisture, e.g., less than about 10% by weight. The process of manufacturing absorbents involves testing the feedstock (cardboard and agricultural products) for moisture. If the moisture content is less than 9% by weight, moisture may be added through steam or light spray during pelletizing. In one example, the operating range is between about 9% and 14% moisture by weight. Typically, one is able to select feedstock with the appropriate moisture content so that no added steam or water is required.

In certain embodiments, the animal bedding compositions are paper based and include principally paper and crop waste in combination. Typically, compacted animal bedding bodies have a composition that is not edible for the animals that will use it. For example, horses may eat compressed products containing more than about 30% edible biomass. Therefore, horse bedding compositions typically contain at most about 30% by weight edible biomass. In some cases, animal bedding products include paper or cardboard, lime, bicarbonate salts, or other inedible components in a total quantity of about 70% by weight or more. Animal bedding compositions may include a small amount of moisture as identified above (e.g., about 4-6% moisture by weight). Small amounts of deodorizing component, soap, and/or vegetable oil may be included as with the cat litter product (e.g., at most about 1% of the composition by weight).

In specific embodiments, the animal bedding composition includes about 70 to 80% by weight cardboard or paper and about 20 to 30% edible biomass such as corn waste products. Additionally, the product may also include lime in an amount of about 0.02% to 0.05% by weight.

In some embodiments, animal bedding is made by processing the feedstock in a shredder and then in hammer mills to reduce the size so it will flow through a pellet die. The fines are removed in the process to eliminate any dust and small particles that might cause respiratory problems in the animals.

Through densification, compacted animal bedding material provides tremendous savings in transportation and storage. If one stores straw or wood chips in its natural state, it will occupy a large volume. In some embodiments, feedstocks are densified by as much as 17 times to provide compacted animal bedding. Of course, different feedstocks compact to differing degrees. In general, the compacted animal bedding product may be used in smaller amounts and will last longer than traditional animal bedding materials. And of course the product is biodegradable and can be composted.

The finally prepared compacted product may be prepared for bedding by spreading in a stall and then slightly wetting the material. For example, 40 pounds of the material may be wetted with about 1 quart of water. Shortly thereafter, typically within about one hour, the pellets expand (sometimes swell to multiple times its initial size) thus giving a deeper and softer bedding. The added moisture has the additional benefit of reducing dust.

The resulting bedding is very absorbent, has excellent deodorizing characteristics and clumps when an animal urinates so that the used portion is easily removed from the stall. The animal's solid waste does not dirty much of the product and is also removed with ease.

### Conclusion

While the invention has been described in terms of certain specific embodiments, it is not so limited. For example, the pellets described herein may be used in a wide range of applications other than industrial power generation, animal bedding, and waste absorbents. Among the other applications are landfill reclamation, and heating for homes.

What is claimed is:

1. A method of preparing a first compacted body comprising first particles comprising biomass, and second particles comprising a different material, wherein the compacted body containing the first particles and the second particles resists fragmentation, the method comprising:
converting biomass feedstock to a form comprising said first particles;
concurrently compacting the first particles and the second particles to produce the first compacted body having an energy content, wherein the compacted body has a total moisture content of about 15% by weight or less; and
adjusting the compacted body composition based on seasonal fluctuations of the biomass feedstock; and
compacting particles employing the adjusted composition to produce a second compacted body having an energy content consistent with that of the first compacted body produced,
wherein the first compacted body has no more than about 300 ppm of chloride.

2. The method of claim 1, wherein said compacting takes place in a briquette press.

3. The method of claim 1, wherein the second particles are coal particles.

4. The method of claim 1, wherein the first component is selected from the group consisting of soybean stocks, sage, corn stocks, and sunflower stocks.

5. The method of claim 1, wherein the compacted body is a pellet or briquette.

6. The method of claim 1, wherein the first particles comprise grass.

7. The method of claim 1, wherein said compacting takes place in a pellet mill.

8. The method of claim 1, wherein the compacted body is combustible.

9. The method of claim 8, wherein the second particles are not combustible.

10. The method of claim 8, wherein the compacted body has an energy density of at least about 7000 BTU per pound when combusted.

11. The method of claim 7, wherein the second particles comprise biomass.

12. The method of claim 1, wherein the compacting is performed with a binder.

13. The method of claim 12, wherein the binder is algae or wax.

14. The method of claim 12, wherein moisture content provided in the biomass feedstock serves as the binder.

15. The method of claim 1, wherein the biomass feedstock is sun-dried.
